(19) United States
(12) Patent Application Publication
(10) Pub. No.: US 2009/0159033 A1
(43) Pub. Date: Jun. 25, 2009

(54) Sparkless ignition plug for the internal combustion engine

(76) Inventors: Robert Lee Steigleman, JR., Mira Loma, CA (US); Jimmy Robert Allen, II, Corona, CA (US)

Correspondence Address: ROBERT LEE STEIGLEMAN JR., 5800 HAMNER AVE, SPACE #631, MIRA LOMA, CA, 91752, US

(21) Appl. No.: 12/315,748

(22) Filed: Dec. 3, 2008

Related U.S. Application Data
(60) Provisional application No. 61/005,669, filed on Dec. 5, 2007.

(51) Int. Cl. F02P 23/04

(52) U.S. Cl. 123/143 B

(57) ABSTRACT

The preferred embodiment according to the present invention is the use of a laser device to ignite fuel for the purpose of producing mechanical power. The laser replaces the spark plug in the internal combustion engine to ignite the air fuel mixture. The hot photons that is created by the laser is used in the same way as the electrons that is created by the spark plug, but the photons need no ionization path, there for the ignition is almost instantaneous.

### CROSS-REFERENCE TO RELATED APPLICATIONS

This application claims the benefits of provisional patent application, Ser. No. 61/005,669, Filed 2007 Dec. 5 by the present inventors, which is incorporated by reference here in.

### FEDERALLY SPONCERED RESEARCH

not applicable

### SEQUENCE LISTINGS OR PROGRAMS

not applicable

### BACKGROUND

1. Field

The present invention relates to the ignition of fuel in mechanical power producing plants such as internal combustion engines and any application that requires the ignition of raw fuel to produce an explosion that is required to generate the power that these machines use to perform work, and more precisely the efficiency of the ability to ignite the fuel by the use of a laser device.

2. Prior Art

In a 4 cycle internal combustion engine, the cycles are, starting at top dead center; this means that the piston is all the way at the top of the cylinder at the start of the cycle. The piston moves downward and the intake valve opens letting the air fuel mixture into the firing chamber, this is the intake cycle. When the piston reaches bottom dead center, the intake valve closes, and the piston moves up compressing the air fuel mixture, this is the compression cycle, and this creates a very fast moving wind storm type environment. When the piston reaches top dead center, the sparkplug will fire causing the compressed air fuel mixture to explode and force the piston downward, this is the power cycle. This is where the fuel is actually turned to kinetic energy that causes the internal combustion engine to operate. When the piston reaches bottom dead center, the exhaust valve will open and the piston will move upward and force the burnt air fuel mixture out of the firing chamber that is an example of 1 revolution of the internal combustion engine. 1 revolution happens, from 800 to over 10,000 times a minute this is called revolutions per minute or RPM'S.

The sparkplug will receive an electric charge of energy from the coil of the distributor system. This is called electro motive force this will cause the positive electrode to be energized with tens of thousands of volts. At that moment it tries to ionize a pathway to ground so as to let the electrons, from the ground, flow to the positive electrode, that flow of electrons is the spark.

Now do to the wind storm effect in the combustion chamber environment the ionization of the pathway is impeded greatly do to the fact that the fast moving air fuel mixture blows the ionized path away from the ground. This happens several times before the pathway is finally established and the electrons can flow through the ionization path like electricity flows in a wire. This happens in less than 0.001 of a second.

The use of an electrostatic discharge, or more basically electrons, to ignite the air fuel mixture in an internal combustion engine has been used exclusively. Even the state of the art sparkplugs of today still face the same problems that are imposable to get around by using static electric discharge. One of these is the fact that the electrodes both the positive and the negative eventually were out by the sparking action and by corrosion of the unburnt air fuel mixture no matter what materials are used. Another is the fact that the spark happens inside the combustion chamber. Were the electro motive force has to be high enough to establish an ionization path from the positive electrode to the negative electrode so that the electrons have a path to flow through, these electrons are very hot, and that is the spark that ignites the air fuel mixture. Now the ionization path can be blown out several times by the turbulent nature of the compressing of the air fuel mixture that is present in the internal combustion engine. This delays the ignition. Another is the fact that the electrodes have to be operated in a certain heat range so that the electrodes will not get to hot and burn up or not get hot enough so as to self clean. Another issue is fouling of the sparkplug. If there is enough unburnt gas accumulation on the electrodes the sparkplug will foul out and not fire at all. If carbon builds up on the electrodes the sparkplug will foul out and not fire at all.

### SUMMARY

In accordance with the present application there is a new method to ignite fuel in an internal combustion engine. This is done by using a laser to heat the fuel to the point of explosion.

### DRAWINGS—FIGURES

FIG. 1 is a frontal cross sectional view of the preferred embodiment according to the present invention, showing an application of a laser plug in an internal combustion engine.

FIG. 2 is an elevated frontal perspective view of a laser plug.

### DRAWINGS—REFERENCE NUMERALS

10=Preferred Embodiment
12=Shell
14=Mounting Threads
16=Mounting Nut
18=Terminal
20=Laserplug
40=Head
42=Piston
44=Piston rod
46=Firing chamber
50=Laser Device
52=Lenses
54=Beam

### DETAILED DESCRIPTION

### Preferred Embodiment:

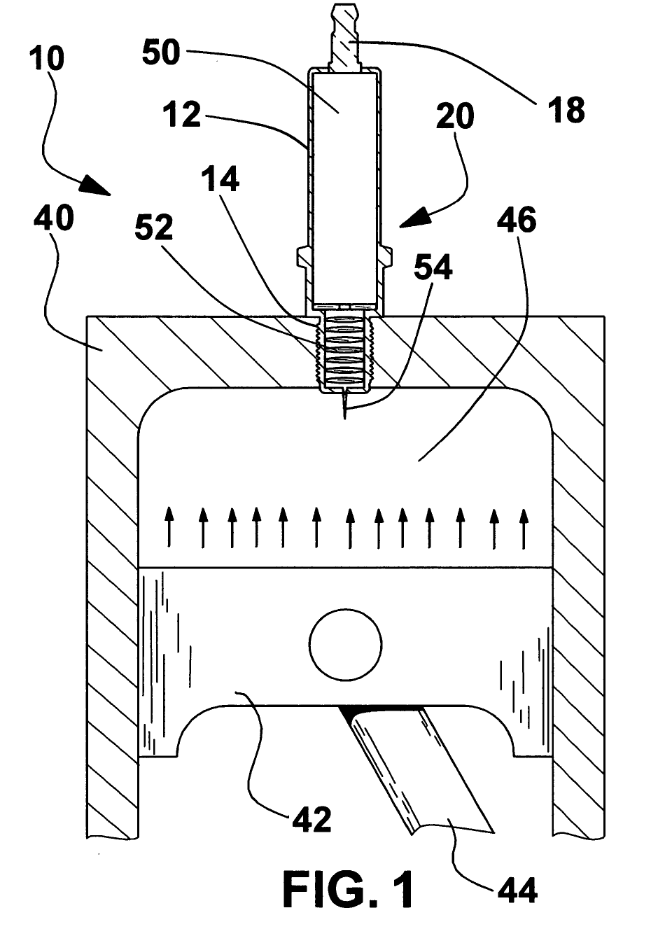

FIG. 1 shows the preferred embodiment 10. Were in the laser plug 20, is constructed with the laser 50 inside the shell 12. The terminal 18 is where the power source is connected. The laser plug 20 is being used in an internal combustion engine. In which parts are the head and cylinder 40, the piston 42, the piston rod 44, and the firing chamber 46. The little arrows show the direction of the piston movement during the compression stroke, were the turbulent nature of the compressing air fuel mixture will make it hard for a conventional sparkplug to ionize a spark path. The laser plug will fire hot photons to ignite the air fuel mixture regardless of the turbulent nature in the combustion chamber. The photons are created by the pumping action of the laser, so as to be the laser beam 54, and will be concentrated so as to be hot enough to ignite the air fuel mixture. In a conventional spark plug the heat of the spark can be adjusted by the size of the gap. In the laserplug this can be achieved by the lenses 52 so as to create the exact heat that the application requires. The laser beam 54 can be adjusted to actually fire at any depth that is required by the application to reach maximum firing potential. In some applications, of the internal combustion engine, there is very little room for the firing end of the spark plug to go any deeper such as in the direction of the piston 42. Making the firing end of the spark plug reach deeper into the chamber ignites the air fuel mixture in its very most center. This helps the air fuel mixture to burn more complete. Another factor is in a conventional spark plug the jumping action of the electrons from one electrode to another, erodes the electrodes so that they eventually were out. In the laserplug there are no electrodes to erode by electro static discharge.

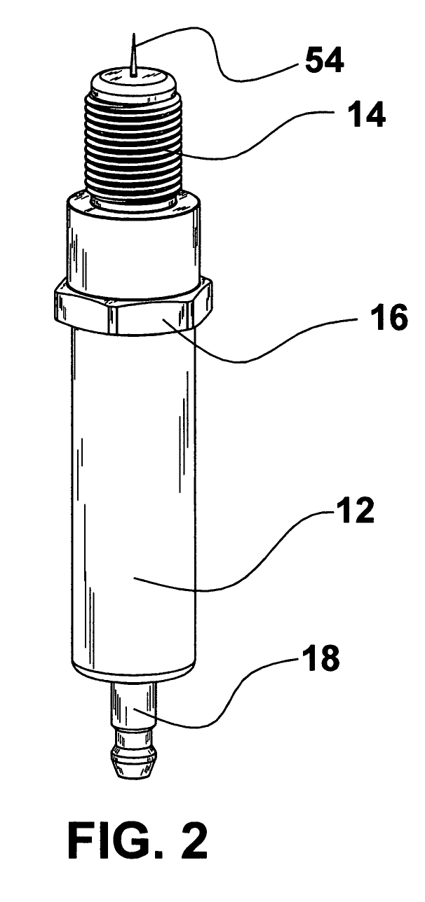

FIG. 2 shows an example of a laser plug, were in the laser beam 54 is concentrated to a hot spot so as to ignite the air fuel mixture. The shell 12 is designed with the mounting threads 14, the mounting nut 16, and the terminal 18, so as to fit into the same applications were conventional spark plugs are being used in now.

Having thus described the method of operation herein, what is desired to be protected by Letters Patent is presented in the subsequently appended claims.

What is claimed is:

1. A method for igniting the fuel in an internal combustion engine comprising a laser to heat the fuel to an effective temperature,
whereby causing the fuel to explode.
